(19) United States
(12) Patent Application Publication
(10) Pub. No.: US 2009/0139670 A1
(43) Pub. Date: Jun. 4, 2009

(54) Blind for windows of motor vehicles

(76) Inventors: Harald Kruger, Bamberg (DE); Manfred Stenzel, Bamberg (DE)

Correspondence Address: CHRISTIE, PARKER & HALE, LLP, PO BOX 7068, PASADENA, CA, 91109-7068, US

(21) Appl. No.: 12/227,329

(22) PCT Filed: May 11, 2007
(86) PCT No.: PCT/EP2007/004347

§ 371 Date: Nov. 14, 2008

(30) Foreign Application Priority Data
May 16, 2006 (DE) 10 2006 023 370.0

(51) Int. Cl. B60J 1/20

(52) U.S. Cl. 160/370.22; 160/405

(57) ABSTRACT

A blind for windows of motor vehicles, in particular of motor vehicle doors or tailgates is provided. The blind comprising a blind web which at least partially covers the window surface, a winding shaft for receiving the blind web, and a blind adjustment mechanism with blind guides for the blind web, a blind drive for winding up and unwinding the blind web, and actuating means for transferring the driving force from the blind drive to the blind web, and an installation unit which receives at least the blind adjustment mechanism and can be connected to parts of the motor vehicle body. The installation unit is connected in at least to part of the interior lining to be fastened to a motor vehicle body, in particular an inner panel of a motor vehicle door or tailgate.

### CROSS-REFERENCE TO A RELATED APPLICATION

This application is a National Phase patent application of International Patent Application Number PCT/EP2007/004347, filed on May 11, 2007, which claims priority of German Patent Application Number 10 2006 023 370.0, filed on May 16, 2006.

### BACKGROUND

The invention relates to a blind for windows of motor vehicles and to a method for installing a blind.

EP 1 123 824 A2 discloses a side window blind for motor vehicles, which has a winding shaft which is mounted rotatably behind the side lining of a motor vehicle door and has a blind web which is wound up thereon, can be pulled out through a slot in the door and covers the vehicle window. The side window blind has a multiplicity of functional elements, including, in addition to the winding shaft and the blind web, a spring motor, guide rails with carriages guided therein, a driving motor and actuating elements which connect the driving motor to the carriages guided in the guide rails, and a bow which is inserted through a tubular pocket in the blind web edge, is laterally connected to the carriages arranged in the guide rails and is oriented parallel to the winding shaft.

For installation of the side window blind, these functional elements have to be connected to one another and/or to the motor vehicle door for the final installation at the automobile manufacturer, with some of the functional elements being fitted to the window frame and some being fitted in the door box behind the door interior lining. The large structure of the side window blind and the long guide tubes required for the actuating elements make the handling during the installation of the side window blind awkward, and because of the numerous functional elements which have to be packaged in a protected manner, the outlay on stockkeeping and transportation of the individual functional elements from the blind manufacturer to the automobile manufacturer is considerable.

A further disadvantage is that checking of the operation of the known side window blind is possible only in the fully installed state, since the driving components and guide components of the side window blind do not form a closed unit with the individual functional elements being functionally connected.

To overcome said disadvantages, DE 102 15 331 A1 discloses a sun blind, which corresponds to the generic term, for windows of motor vehicle doors, the sun blind having a blind web which at least partially covers the window surface, a winding shaft for receiving the blind web, and a blind adjustment mechanism which contains blind guides for supporting the blind web unwound from the winding shaft, a blind drive for winding the blind web onto the winding shaft and unwinding the blind web from the winding shaft, and actuating means for transmitting the driving force from the blind drive to the blind web. The blind adjustment mechanism is arranged on an installation module having a support element which can be inserted into the door box of the motor vehicle door, as a result of which the outlay on production, the stockkeeping and the transportation of a sun blind for windows of motor vehicles are simplified, the outlay on fitting the sun blind into a motor vehicle door is significantly reduced, and pre-checking of the operation of the sun blind is made possible such that a closed, pre-checked installation module for a sun blind can be provided at the installation site for final installation.

### SUMMARY

The present invention is based on the object of further simplifying and reducing the costs of production, installation, stockkeeping and transportation to the installation site of a blind for motor vehicles with optimum use of the construction space available for arranging a blind in parts of a motor vehicle, with provision of a multiplicity of variant embodiments, creation of short laying paths for the actuating means of the blind, fewer problems concerned with tolerances, and integration of fastening elements while retaining the option of fully pre-checking of the operation of the blind prior to the final installation.

The exemplary solution according to an exemplary embodiment of the invention results in a further simplification of the production, installation and stockkeeping and of the transportation of a blind for motor vehicles with simultaneous optimum use of the construction space available in a motor vehicle for the arrangement of a blind.

In addition, the connection of the installation unit to at least part of the interior lining which is to be fastened to the motor vehicle body, in particular to an inner panel of a motor vehicle door or tailgate, permits full pre-checking of the functional elements at least of the blind adjustment mechanism received by the installation unit, since the parts of the blind adjustment mechanism are connected to one another in a functionally ready manner and no functional elements have to be removed or functionally essential parts of the blind adjustment mechanism added at the final installation site. Furthermore, short laying paths for the actuating means of the blind, fewer problems concerned with tolerances, a simple formation of variants and optimum use of the construction space in the parapet region, and also integration of fastening elements are ensured.

The use of the construction space available for the arrangement of a blind can be further optimized, and the outlay on production and installation further reduced, by the installation unit being integrated in the interior lining, and therefore the installation unit and the interior lining form an independent component which can be produced and can be handled uniformly, with additional connecting and fastening elements becoming superfluous as a result of the merging of installation unit and interior lining.

As an alternative, the interior lining can comprise a frame lining covering the window frame of a door or tailgate, or an, in particular, upper parapet lining of a motor vehicle door or tailgate, and can therefore permit optimum use of construction space in the region of the frame and parapet.

In one exemplary embodiment of the invention, the frame lining or parapet lining is composed of a plurality of frame lining regions or parapet lining regions which are separated from one another, and therefore permits the integration of all of the functional elements of a blind, including the blind adjustment mechanism, the winding shaft and the blind guides, in frame lining regions and parapet lining regions, with the resultantly obtainable optimum use of construction space and simplification of the production and installation while retaining the option of fully pre-checking the operation of the blind before the final installation.

An advantageous refinement of the exemplary solution according to an exemplary embodiment of the invention is characterized in that receiving elements for at least some of the components (winding shaft, blind guide, blind drive, actuating means) of the blind are integrated on that side of the interior lining, frame lining or parapet lining which, in the fitted state, faces the motor vehicle body.

By means of the integration of the receiving elements in the rear side of the interior lining, frame lining or parapet lining, simple production of the lining parts, for example by injection molding of plastic is guaranteed and ensures that the functional elements of the blind can be placed securely in the body part assigned to the lining during the final installation.

A variant of the exemplary solution according to an exemplary embodiment of the invention is characterized in that the blind guides are connected adjustably, in particular foldably, to the interior lining, frame lining or parapet lining.

The foldable arrangement of the blind guides makes it possible, for example, for the blind adjustment mechanism to be integrated in the frame lining or parapet lining of a motor vehicle door or tailgate while the blind guides are oriented parallel to the frame lining or parapet lining in a transportation position, but, during the final installation, are folded up into the side regions of the window in order to guide the blind web.

Furthermore, the installation unit can have pre-positioning means and/or installation aids for connecting the blind module, which is formed from the installation unit and the frame lining or parapet lining, to the motor vehicle body or door body or tailgate, said means/aids ensuring secure positioning of the blind in the relevant part of the body.

A further exemplary refinement of the invention is characterized by a complete blind module which contains the blind adjustment mechanism, the winding shaft and the interior lining, frame lining or parapet lining and which ensures rapid, easy installation, minimum problems concerned with tolerances, if any at all, and an optimum use of construction space.

In the case of an installation unit which is arranged on an interior lining or frame lining, it is possible, with respect to a motor vehicle door or tailgate, for the winding shaft to be arranged above the window cut-out, the blind guides to be arranged at the sides of the window cut-out, and the blind drive and also the actuating means to be arranged below the window cut-out of the motor vehicle door or tailgate.

Furthermore, the blind module can contain additional operating elements and/or an electronic control system for the blind, as a result of which the construction space in the parapet region is optimally used and rapid installation in the motor vehicle door or tailgate ensured.

Integration of the complete blind module, which contains the winding shaft, or of a partial blind module, which merely contains the blind adjustment mechanism, in the interior lining, frame lining or parapet lining permits fastening to the inner panel of the motor vehicle door or of the tailgate from the outer side thereof in order to avoid apertures in the interior lining, frame lining or parapet lining, or fastening below the parapet cover which is covered by the remaining lining. As a result less construction space is required in the window frame region, as are fewer parts, since the cover at the same time takes on the guide function for guiding the blind. Integration in a parapet lining part with arrangement of the components of the blind (drive, guide, blind box, control system, switch bank) in the parapet region, and integration of the receiving elements for components in the rear side of the parapet lining part result in simple integration of the switches and electronics, simplified formation of variants and decoupling from the inner panel and therefore decoupling of the noise produced by the driving motor.

The blind module can comprise further functional units of the motor vehicle door or of the tailgate, such as a window lifter, a wiper drive for a tailgate window wiper, a door lock, a cable harness or the like.

The blind guides can exemplary be connected to the blind drive via flexible actuating means which, in particular, comprise pitch cables in flexible tubular guides.

A method for installing a blind for windows of motor vehicles, in particular of motor vehicle doors or tailgates, with the abovementioned functional elements combined to form an installation unit, is characterized in that, in a pre-installation operation, the blind adjustment mechanism and, if appropriate, the winding shaft with the blind web wound up thereon are pre-installed on a frame lining on an interior lining, frame lining or parapet lining of part of the motor vehicle body, in particular of an inner panel of a motor vehicle door or of a tailgate, the operation of the blind adjustment mechanism which is pre-installed on the interior lining, frame lining or parapet lining, if appropriate with the winding shaft, is pre-checked, and, in a final installation phase, either the blind adjustment mechanism which is pre-installed on the interior lining, frame lining or parapet lining with the winding shaft with the blind web wound up thereon, or the blind adjustment mechanism with the winding shaft, is fastened to part of the motor vehicle body, in particular to the inner panel of the motor vehicle door or tailgate.

If the blind adjustment mechanism and winding shaft are arranged separately, the blind adjustment mechanism and the winding shaft can be pre-installed on different regions of the interior lining or frame lining of the complete blind module.

### BRIEF DESCRIPTION OF THE DRAWINGS

Further features and advantages of the invention will be explained in more detail with reference to exemplary embodiments which are illustrated in the figures, in which:

FIG. 1 shows a schematic view of a motor vehicle door with a window cut-out for a two-part window.

FIG. 2 shows a schematic view of a blind module with functional elements of a blind which are arranged on a frame lining.

FIG. 3 shows a schematic illustration of a blind adjustment mechanism, which is to be connected to part of a frame lining or to a parapet lining, in the form of a smallest installation unit.

FIG. 4 shows a schematic illustration of a blind module which is to be connected to a frame lining or parapet lining and contains the winding shaft.

FIG. 5 shows a schematic illustration of a tailgate module with functional elements of a blind which are arranged on a frame lining.

FIG. 6 shows a schematic illustration of the connection of a tailgate module to a parapet lining of a tailgate.

FIG. 7 shows a schematic illustration of the connection of a tailgate module to a frame lining for a tailgate with the winding shaft mounted above the window cut-out.

### DETAILED DESCRIPTION

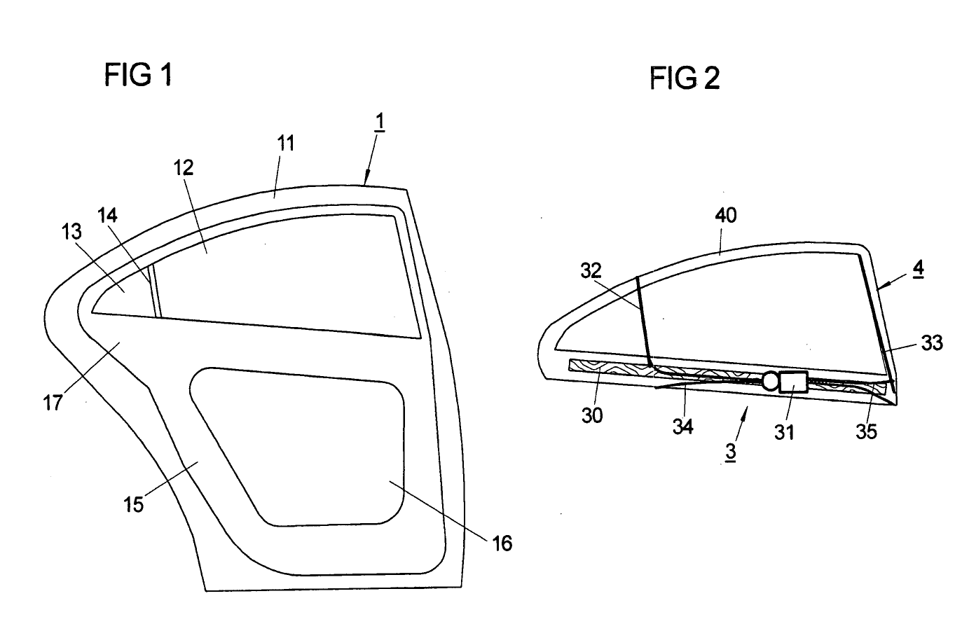

FIG. 1 shows a schematic view of a motor vehicle door 1 which is composed of a door outer panel and a door inner panel and has a door window frame 11 which surrounds a two-part window having a vertically movable window 12 and a stationary window 13 which are separated from each other by an intermediate web 14, and with a door box 15 having a door cut-out 16 between which and the door window frame 11 a door parapet 17 runs below the two-part window.

To cover the vertically movable window 12 and the stationary window 13, use is made of a blind 3 (illustrated schematically in FIG. 2) which is composed of a winding shaft 30, a blind web which can be wound up onto the winding shaft 30 and can be unwound from the winding shaft 30, and a blind adjustment mechanism with a blind drive 31, blind guides 32, 33 and actuating means 34, 35. The blind guides 32, 33 comprise, for example, guide rails with sliding and/or guide elements guided therein, and the actuating means 34, 35 comprise pitch cables arranged in flexible tubular guides, cables guided via deflecting pulleys, or pressure-resistant adjustment elements, the ends of which are connected either to the blind drive 31 or to the sliding and/or guide elements arranged in the blind guides 32, 33. The sliding and/or guide elements in turn are connected directly or via a tension bow to the blind web edge of the blind web, which edge lies opposite the blind web edge which is connected to the winding shaft 30.

By actuation of the blind drive 31, the blind web is unwound from the winding shaft 30 or wound up onto the winding shaft 30, with it also being possible for a spring drive connected to the winding shaft 30 to be used for winding up the blind web onto the winding shaft 30.

The blind 3 is connected to a frame lining 40 which is matched to the contour of the door window frame 11 and is placed onto the door window frame 11 in such a manner that the functional elements 30 to 35 of the blind 3 are arranged between the frame lining 40 and the door inner panel of the motor vehicle door 1. The blind 3 and the frame lining 40 together form a blind module 4, the functional elements 30 to 35 of the blind 3 either being integrated in the frame lining 40 by means of corresponding shaping thereof, such that additional fastening elements can be dispensed with, or being connected to the frame lining 40 by an arrangement of receiving elements in the rear side or inner side of the frame lining 40.

By means of the arrangement of pre-positioning means and installation aids and by means of the use of clips, the blind module can be placed onto the door inner panel of the motor vehicle door 1 for final installation and can be connected to the door body by being pressed on or latched therein in some other way.

Since all of the functional elements 30 to 35 of the blind 3 are pre-installed on the frame lining 40 in order to form the blind module 4, the operation of the blind 3 can be fully pre-checked prior to the final installation such that, if the need arises, individual functional elements can be exchanged or readjusted.

In addition to the functional elements 30 to 35 (illustrated schematically in FIG. 2) of the blind 3, further elements can be inserted, such as, for example, operating switches, sensors, a cable harness or the like, which are required for operating the blind 3 and connecting it to the motor vehicle battery and electronic control system. In this case, the operating switches can be positioned in particular in such a manner that, after the final installation, they are arranged in the parapet region 17 of the motor vehicle door 1 and are therefore easily reachable by a vehicle occupant.

As a result of the blind 3 being integrated in the frame lining 40, in addition to simplified production and installation and the possibility of pre-checking the complete blind module 4, optimum use of space and configuration of the interior space are ensured, since the functional elements 30 to 35 of the blind 3 are covered toward the interior space of the motor vehicle by the interior lining 40 of the blind module 4.

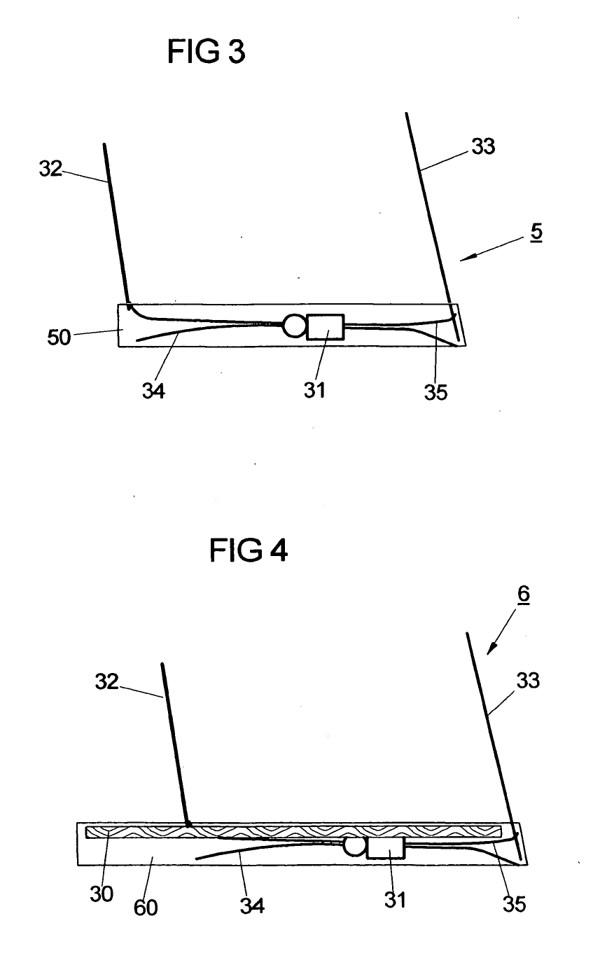

As an alternative to all of the functional elements 30 to 35 of the blind 3 being connected to or integrated in a frame lining 40 matched to the contour of the door window frame 11, it is possible, according to FIG. 3, for the blind adjustment mechanism comprising the blind drive 31, the blind guides 32, 33 and the actuating means 34, 35 to be pre-installed on part of a frame lining or of a parapet lining 50. The resultantly formed partial blind module 5 constitutes an extremely small installation unit and is suitable in particular for applications in which there is no door window frame surrounding a window cut-out. In this variant embodiment, the winding shaft with the blind web wound up thereon is to be attached to the motor vehicle door separately from the partial blind module 5 and is to be connected to the sliding and/or guide elements of the blind 3.

The operation of the partial blind module 5 can also be fully pre-checked, and therefore satisfactory operation of the functional elements 31 to 35 of the partial blind module 5 can be checked and ensured before the final installation.

In order to avoid damage to the blind guides 32, 33 during transportation from the pre-installation location to the final installation location and in order to obtain a compact transportation position of the partial blind module 5, the blind guides 32, 33 are preferably connected foldably to the parapet lining 50 and can be brought from the functional position, illustrated in FIG. 3, into a transportation position in which they are oriented substantially parallel to the longitudinal extent of the parapet lining 50.

A further embodiment which is illustrated schematically in FIG. 4 corresponds to a blind module 6 in which, in addition to the variant illustrated in FIG. 3, the winding shaft 30 of the blind 3 is connected to a parapet lining 60 such that the blind module 6 forms a complete installation unit with a blind 3, which can likewise be fully pre-checked, and can be used for applications in which the arrangement of a blind module according to FIG. 2 is not possible or is not desired.

The solution according to the invention is also suitable in the same manner for other body regions of a motor vehicle, for example also for motor vehicle rear windows which are not vertically adjustable but rather can merely be opened out, with the functional elements of a blind being arranged in the interior lining which surrounds the window or is provided below the window.

A further use of the solution according to the invention is illustrated in FIGS. 5 to 7 and concerns an installation unit which is to be connected to the tailgate 2 of a motor vehicle.

FIG. 5 shows, in a schematic illustration, a contour (illustrated by a dashed line) of a tailgate 2 and of a blind module 7 analogously to the blind module 4 according to FIG. 2, said blind module in this case being matched to a tailgate window frame and being connected to the tailgate window frame in the finally installed state. The tailgate blind 3 which is composed of the functional elements winding shaft 30, blind drive 31, blind guides 32, 33 and actuating means 34, 35 is completely pre-installed on a frame lining 70, with the blind guides 32, 33 being arranged in the lateral regions of the frame lining 70 while the winding shaft 30 and the blind drive 31 are placed in that region of the tailgate 2 which is arranged below the tailgate window cut-out.

Also in this embodiment, full pre-checking of the window blind 3 prior to the final installation is possible, and therefore satisfactory operation of the tailgate blind 3 is ensured upon the final installation.

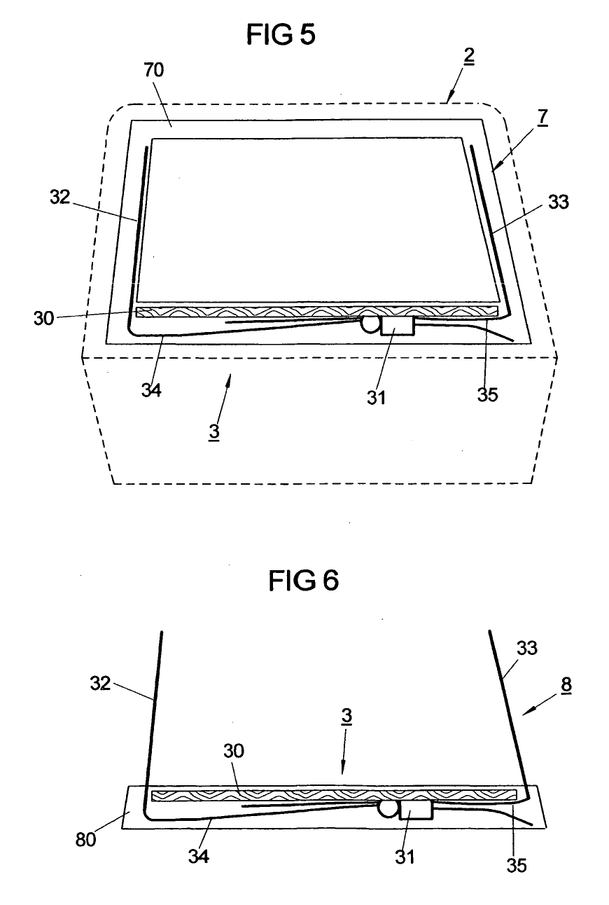

Instead of a complete blind module, a partial blind module 8 (illustrated in FIG. 6), in which the functional elements 30 to 35 of the blind 3 are fitted on a parapet lining 80 for a tailgate 2, can also be provided for this application. In addition to the pre-checking of the pre-installed partial blind module 8 that can likewise be carried out, a foldable arrangement of the blind guides 32, 33 can be provided, said arrangement permitting a space-saving transportation position of the partial blind module 8 for a tailgate and avoiding damage to the blind guides 32, 33 during transport.

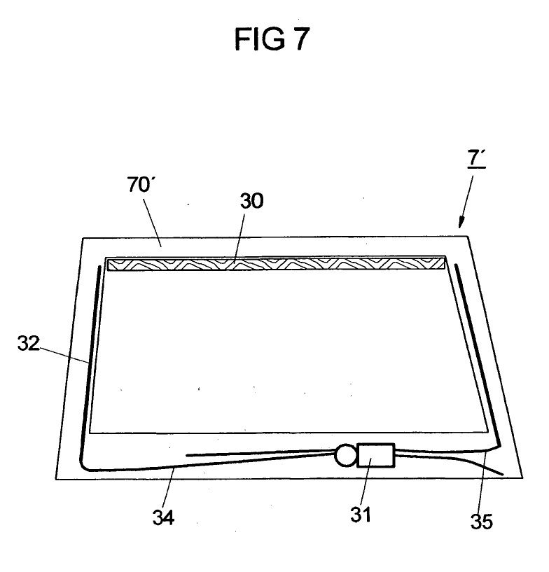

FIG. 7 shows an arrangement, corresponding to the complete blind module 7 according to FIG. 5, of a modified blind module 7′, in which, in contrast to the blind module 7 according to FIG. 5, the winding shaft 30 is arranged on the frame lining 70′ in the web running above the tailgate window cut-out while the blind guides 32, 33 are arranged, analogously to the embodiments according to FIG. 5, in the lateral frame regions of the frame lining 70′, and the blind drive 31 is arranged in that region of the frame lining 70′ which runs below the tailgate window cut-out.

In particular in the embodiments of the complete blind module 4 according to FIG. 2 and of the modified blind module 7′ according to FIG. 7, subdivision of the blind modules 4 and 7′ into a plurality of individual regions and the assembly thereof during the final installation are possible. In this case, the individual regions of the modified blind module 7′ can be coordinated with one another during the pre-installation operation and can be brought into an exact matching shape such that it is ensured that they can be fitted in the tailgate during the final installation.

Also in the embodiments according to FIGS. 3 to 7, the final installation of the partial blind modules 5, 6 and 8 and of the complete blind modules 4, 7 and 7′ can be simplified by the arrangement of pre-positioning means and installation aids, such as clips and the like. In all of the embodiments of a blind module or partial blind module, a closed design is ensured, with the parapet lining, frame lining or interior lining ensuring a visually optimum configuration of the installation and connection of a blind to, in particular, a motor vehicle door or tailgate.

1-16. (canceled)

17. A blind for windows of motor vehicles with a blind web which at least partially covers a window surface, a winding shaft for receiving the blind web, and a blind adjustment mechanism with blind guides for the blind web, a blind drive for winding up and unwinding the blind web, and actuating means for transferring the driving force from the blind drive to the blind web, and an installation unit which receives at least the blind adjustment mechanism and can be connected to parts of the motor vehicle body, wherein the installation unit is connected in at least to part of an interior lining, a frame lining or a parapet lining to be fastened to a motor vehicle body.

18. The blind of claim 17, wherein the installation unit is integrated in the interior lining.

19. The blind of claim 18, wherein the interior lining comprises a frame lining, in particular a doorframe lining or tailgate lining.

20. The blind of claim 18, wherein the interior lining comprises a parapet lining of a motor vehicle door or tailgate.

21. The blind of claim 18, wherein the interior lining or frame lining or parapet lining comprises a plurality of lining regions which are separated from one another.

22. The blind of claim 17, wherein receiving elements for at least one of said winding shaft, blind drive, blind guides and actuating means, are integrated on a side of the interior lining or frame lining or parapet lining for facing the motor vehicle body.

23. The blind of claim 17, wherein the blind guides are connected adjustably to the interior lining or frame lining or parapet lining.

24. The blind of claim 17, wherein the installation unit has at least one of a pre-positioning means and installation aids for connecting the installation unit to the motor vehicle body.

25. The blind of claim 17, wherein said blind adjustment mechanism, the winding shaft and the interior lining or frame lining or parapet lining form of complete blind module.

26. The blind of claim 17, wherein the winding shaft is arranged above a window cut-out of a motor vehicle door or tailgate, the blind guides are arranged at the sides of the window cut-out of the motor vehicle door or tailgate, and the blind drive and the actuating means are arranged below the window cut-out of the motor vehicle door or tailgate on a frame lining of said interior lining.

27. The blind of claim 25, wherein the blind module comprises additional operating elements and/or an electronic control system for the blind.

28. The blind of claim 25, wherein the blind module comprises further functional units of a motor vehicle door or of a tailgate, such as a window lifter, a wiper drive, a door lock, a cable harness or the like.

29. The blind of claim 17, wherein the blind guides are connected to the blind drive via flexible actuating means.

30. A method for installing a blind for windows of motor vehicles with a blind web which at least partially covers a window surface, a winding shaft for receiving the blind web, a blind adjustment mechanism with blind guides for supporting the blind web unwound from the winding shaft, a blind drive for winding up and unwinding the blind web, and actuating means for transmitting the driving force from the blind drive to the blind web, and with an installation unit which receives at least the blind adjustment mechanism and is to be connected to parts of the motor vehicle body wherein
in a pre-installation phase, the blind adjustment mechanism is pre-installed on an interior lining, frame lining or parapet lining of part of the motor vehicle body,
the operation of the blind adjustment mechanism which is pre-installed on the interior lining, frame lining or parapet lining is pre-checked, and
in a final installation phase, the blind adjustment mechanism which is pre-installed on the interior lining, frame lining or parapet lining is connected to the winding shaft with the blind web wound up thereon, and the interior lining, frame lining or parapet lining is fastened to part of the motor vehicle body.

31. A method for installing a blind for windows of motor vehicles, with a blind web which at least partially covers a window surface, a winding shaft for receiving the blind web, a blind adjustment mechanism with blind guides for supporting the blind web unwound from the winding shaft, a blind drive for winding up and unwinding the blind web, and actuating means for transmitting the driving force from the blind drive to the blind web, and with an installation unit which receives at least the blind adjustment mechanism and is to be connected to parts of the motor vehicle body, wherein
in a pre-installation phase, the blind adjustment mechanism and the winding shaft with the blind web wound up thereon are pre-installed on an interior lining, frame lining or parapet lining of part of the motor vehicle body,
the operation of the blind adjustment mechanism which is pre-installed on the interior lining, frame lining or parapet lining with the winding shaft is pre-checked, and
in a final installation phase, the blind adjustment mechanism which is pre-installed on the interior lining, frame lining or parapet lining with the winding shaft is connected to part of the motor vehicle body.

32. The method of claim 30, wherein the blind adjustment mechanism and the winding shaft are pre-installed on different regions of the interior lining, frame lining or parapet lining.

33. The method of claim 31, wherein the blind adjustment mechanism and the winding shaft are pre-installed on different regions of the interior lining, frame lining or parapet lining.

34. The blind of claim 17 wherein the window is selected from the group of motor vehicle windows.

35. The method as recited in claim 30 said interior lining, frame lining or parapet lining is fastened to an inner panel part of a door or tailgate of the motor vehicle body.

36. The method as recited in claim 31 said interior lining, frame lining or parapet lining is fastened to an inner panel part of a door or tailgate of the motor vehicle body.

37. A blind for windows of motor vehicles with a blind web which at least partially covers a window surface, a winding shaft for receiving the blind web, and a blind adjustment mechanism with blind guides for the blind web, a blind drive for winding up and unwinding the blind web, and an actuator for transferring the driving force from the blind drive to the blind web, and an installation unit which receives at least the blind adjustment mechanism and can be connected to parts of the motor vehicle body, wherein the installation unit is connected in at least to part of a interior lining, a frame lining or a parapet lining to be fastened to a motor vehicle body.
